(19) United States
(12) Patent Application Publication
(10) Pub. No.: US 2014/0252811 A1
(43) Pub. Date: Sep. 11, 2014

(54) CENTER CONSOLE AUDITORIUM TRAY

(71) Applicant: Kelly Michael Whalen, Worthington, OH (US)

(72) Inventor: Kelly Michael Whalen, Worthington, OH (US)

(73) Assignee: HONDA MOTOR CO., LTD., Tokyo (JP)

(21) Appl. No.: 13/791,317

(22) Filed: Mar. 8, 2013

(51) Int. Cl. B60N 3/00

(52) U.S. Cl. CPC B60N 3/002
USPC 297/144; 297/135; 297/173

(57) ABSTRACT

A tray assembly for an associated automotive vehicle has front, first and second side-by-side seats separated by a console. The tray assembly includes a tray mounted to a side of one of the seats or to the console between the front seats. A mounting assembly receives the tray for movement between a first, storage position spaced from the seat portion of the second seat alongside one of (i) a side of the second seat and a (ii) a top of the console, and a second, deployed position wherein at least a portion of the tray is configured to rest on at least a portion of the seat portion of the second seat.

### BACKGROUND

This disclosure is directed to a tray, and particularly a tray mounted in an automotive vehicle. The disclosure finds particular application in a vehicle where first and second front seats are disposed in a spaced, side-by-side orientation and that may or may not include a console disposed between the front seats. However, the disclosure may find application in related environments and uses that are faced with similar difficulties and constraints.

It is common to provide storage areas and cupholders in automotive vehicles. For example, multiple cupholders are desired by vehicle occupants. A common location to incorporate the cupholders is on a center tray or console disposed between the front seats. Unfortunately, the remaining tray space is insufficient for all of the items that many drivers today require to be close by. For example, tray space is required for food, mobile phones, portable navigation systems, music devices, et

In other instances, some vehicles include a center console that has a large armrest. The large armrest is incapable of holding items on its top surface. As a result, many vehicle users store items on the cushion surface of the adjacent seat. However, the seat cushion or seat portion of the adjacent seat is typically sloped and/or presents a large, wide open area. Items can slide off the seat to the floor or slide across the seat cushion and, as a result, the items can slide out of convenient reach for the driver, or may even slide off of the seat portion of the adjacent front seat. As a result, the items occasionally slide off the seat cushion of the adjacent seat and become lost between the door lining and the seat.

Still further, when the driver uses the adjacent front seat as a storage surface, the seat fabric is exposed to food items. Since the items are not secured from sliding, this raises the potential that food can spill onto the seat fabric and result in staining.

Consequently, a need exists for an improved tray assembly that provides additional and organized tray space for items that now are commonly stored in the vehicles. It is also desired that the tray can be neatly stored out of the way when not in use so that the adjacent front seat can be used by a passenger. Preferably, storage of the tray is easily accomplished and presents an aesthetically desirable look to the vehicle interior.

### SUMMARY

A tray assembly for an associated automotive vehicle having first and second side-by-side seats is provided. The tray assembly includes a tray portion mounted between the first and second side-by-side seats. A mounting assembly receives the tray portion for movement between a first, storage position located substantially below the seat portion of the second seat and a second, deployed or in-use position where at least a portion of the tray portion is configured to rest on the seat portion of the second seat.

The first and second positions of the tray portion are substantially perpendicular to one another.

The mounting assembly is positioned along a vertically extending face of a center console interposed between the first and second seats.

The mounting assembly includes a recess formed in a sidewall of a console interposed between the first and second seats, and the recess has a depth that closely approximates a thickness of the tray.

The mounting assembly includes a recess formed in a sidewall of the seat or console. The recess has a depth that closely approximates a thickness of the tray and at least one vertically extending edge of the recess includes a channel or slot dimensioned to receive a projection extending outwardly from a perimeter edge of the tray and allowing selective sliding movement relative to the channel so that the tray can be moved between the first and second positions.

A primary benefit is the provision of a tray assembly that increases the amount of free space to accommodate an increased number of items.

Another advantage resides in the ability to support the items in a manner that the items do not slide off the seat.

Yet another benefit is the ability to conveniently stow the tray portion in an aesthetically pleasing manner when not in use.

Still other benefits and advantages may be found upon reading and understanding the following detailed description

### BRIEF DESCRIPTION OF THE DRAWINGS

FIG. 1 is a schematic illustration of a first lid type tray assembly.

FIG. 2 schematically illustrates an alternative embodiment of a tray assembly mounted to a front seat and deployed for at least partial receipt on a region of the seat portion.

FIG. 3 is a schematic illustration of yet another alternative embodiment where the tray assembly is mounted to a center console.

FIG. 4 is a schematic illustration of the embodiment of FIG. 3 with the tray assembly in a deployed or in-use position.

FIG. 5 is a perspective view of the recess with the tray of FIGS. 3-4 removed.

FIG. 6 is an enlarged detail view of a first corner of the tray interconnected with the console.

FIG. 7 is a view taken generally in the direction of reference arrow 7 in FIG. 5.

FIG. 8 is an enlarged detail view of a second corner of the tray interconnected with the console.

FIG. 9 is view taken generally in the direction of reference arrow 9 in FIG. 5.

FIG. 10 shows the tray assembly of FIGS. 3-4 in a stowed or storage position along a side of the center console.

FIG. 11 illustrates a first step in deploying the tray assembly of FIGS. 3-4 for use.

FIG. 12 also illustrates the first step in deploying the tray assembly of FIGS. 3-4 for use as shown from a different angle.

FIG. 13 is a view from substantially the same angle as FIG. 12 illustrating the tray assembly of FIGS. 3-4 in use.

### DETAILED DESCRIPTION

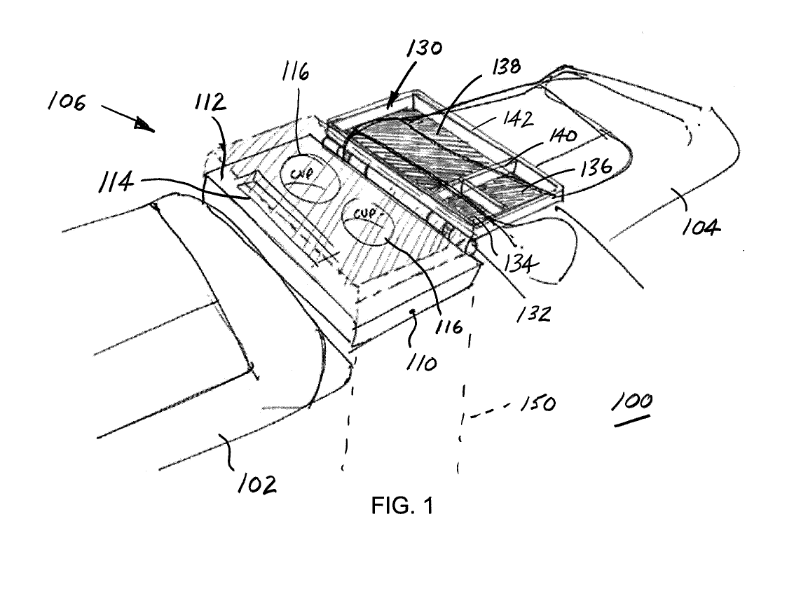

Turning initially to FIG. 1, there is shown a portion of a vehicle interior 100 and more specifically spaced apart, side-by-side first and second front seats 102, 104. An auditorium tray assembly, that is more particularly referred to as a console lid type tray assembly 106 in this first embodiment, is situated between the front seats 102, 104. The tray assembly 106 includes a first or lower tray portion 110 that may form a part (e.g., an upper surface) of a static structure or a movable structure as will be described in greater detail below. For purposes of the discussion, the first tray portion 110 may include one or more recesses in an upper surface 112. The upper surface 112 preferably includes an elongated recess 114 for storing various items and one or more generally circular-shaped recesses that serve as cupholders 116. Thus, the first tray portion 110 is similar to known, existing trays disposed between the first and second front seats 102 (front driver seat), 104 (front passenger seat) of an automotive vehicle (where the seat backs of the front seats have been removed for ease of illustration and only the seat portions of each seat 102, 104 are shown).

A second or upper tray portion 130 is mounted to the first tray portion 110 for selective movement relative thereto. In this illustrated arrangement, a hinge 132 is advantageously provided along one edge to attach together the first and second tray portions 110, 130. When disposed in a first or storage position (shown in broken line in FIG. 1), the second tray portion 130 overlies and substantially covers the first tray portion 110, thereby serving as a lid/cover over the upper surface 112 of the first tray portion. In this manner, the recess 114 and cupholders 116 of the first tray portion 110 are covered by the second tray portion 130 in this configuration of the tray portions. In fact in the storage position, the second tray portion 130 has substantially the same perimeter dimension as the first tray portion 110.

However, when the second tray portion 130 is pivoted approximately 180 degrees about the hinge 132 from its storage position to a deployed position, at least part of the second tray portion is at least partially received on the seat portion of the adjacent front seat 104. That is, one edge of the second tray portion 130 is supported by the first tray portion 110 via the hinge 132. A second edge, and preferably a larger region, of the second tray portion 130 rests on the upper surface of the seat portion or seat cushion of the front passenger seat 104. When disposed in the deployed position shown in solid line in FIG. 1, it is evident that an upwardly facing surface of the second tray portion 130 is preferably subdivided into compartments 134, 136, 138 segregated by one or more dividing walls 140 and a perimeter wall 142. In this manner, walls 140, 142 define recessed compartments 134, 136, 138 that conveniently hold various items such as food, snacks, mobile phone, pen, coins, music devices, portable navigation equipment, etc. (not shown). One skilled in the art will recognize that this list of items that may be held or stored in one or more of the compartments 134, 136, 138 is only exemplary and not intended to be exhaustive of all items that a vehicle user may include. Further, the substantially planar surfaces of the compartments may be formed of a non-slip material if desired to limit sliding of the items stored in the compartments during vehicle travel.

It will be appreciated that the tray assembly 106 may be mounted onto a static center console 150 shown in broken line between the first and second seats 102, 104. Alternatively, the tray assembly 106 (namely, first tray portion 110 and second tray portion 130) may be stored in a storage position (such as alongside one of the first and second seats), partially deployed to the horizontal position illustrated in FIG. 1, and completely deployed where the second tray portion 130 is opened as shown in solid line in FIG. 1. When fully opened, the tray assembly includes the upper surface 112 of the first tray portion 110 so that the vehicle driver has access and use of the recess 114 and cupholders 116, as well as the compartments 134, 136, 138 of the second tray portion.

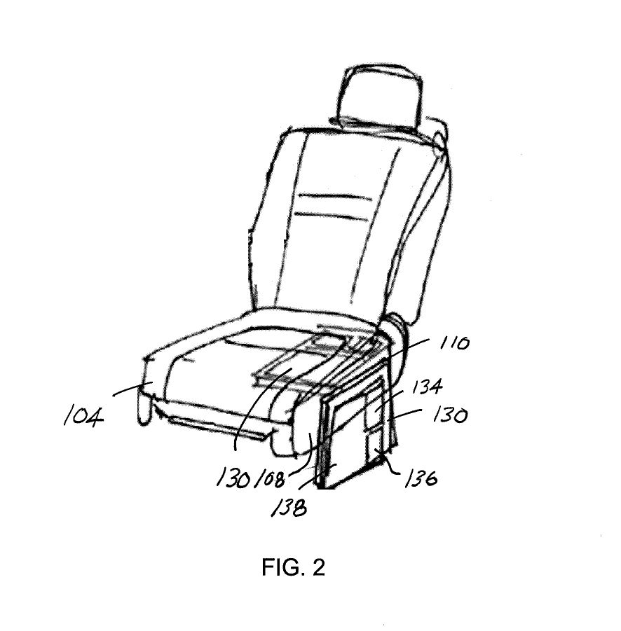

As additionally shown in FIG. 2, the tray assembly 106 of FIG. 1 may be stowed in a storage position adjacent a front passenger seat 104. That is, the tray assembly 106 is mounted to the base or side portion 108 of the seat at a location preferably below the upper surface of the seat cushion or seat portion 104. In the storage position, the tray assembly 106 adopts a substantially vertical orientation thereby leaving a gap between the spaced, side-by-side front seats 102, 104 (only seat 104 being shown in FIG. 2). When deployed to the use position illustrated in FIG. 1, the tray assembly 106 is then at least partially supported on the seat portion 104. Thus, the tray assembly is rotated through approximately 270 degrees from the storage position to the deployed position in this embodiment.

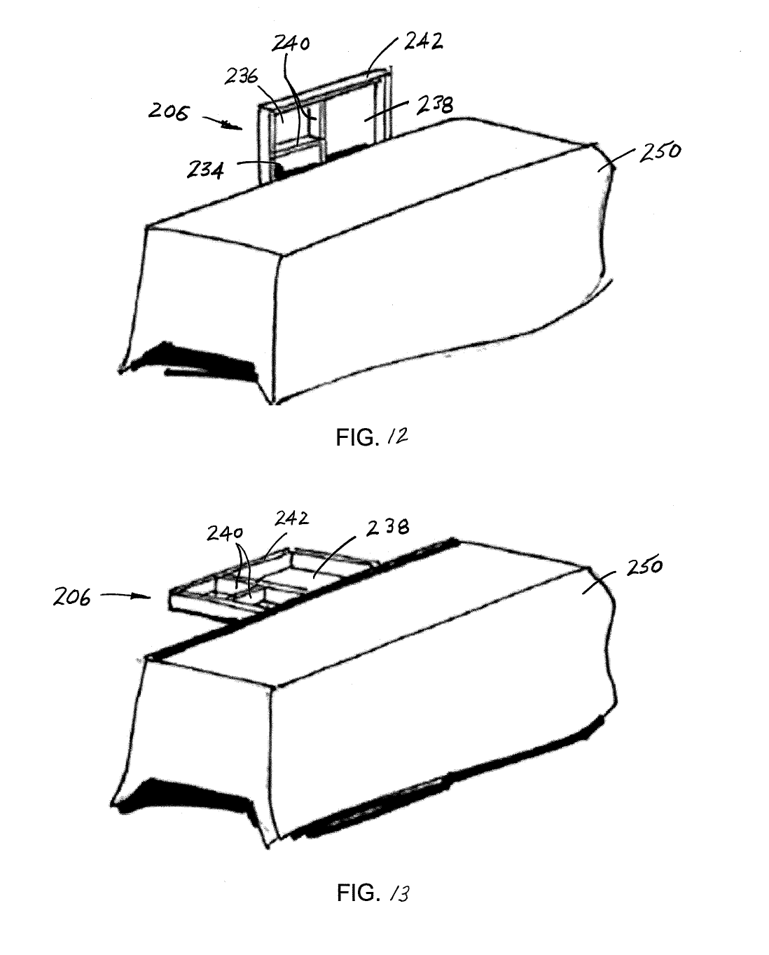

FIGS. 3-13 illustrate another embodiment of the present disclosure. For ease of reference and understanding, like reference numerals in the “200” series will be used to describe like components (e.g. tray assembly 106 in FIG. 1 is referred to as tray assembly 206 in FIGS. 3-13). More specifically, tray assembly 206 is situated between the first and second seats 202, 204 of the vehicle. The seats are disposed in side-by-side relation, separated by a center console 250. In this embodiment, the tray assembly 206 is flush mounted to a sidewall 252 (situated adjacent the second seat 204) of the center console 250 in a first, stowed or storage position. The stowed position of the tray assembly 206 is illustrated in solid line in FIG. 3. The tray assembly 206 is deployed from the stowed position in a first, substantially vertically upward sliding movement relative to the center console 250, and then pivoted or rotated through approximately 90° so that at least a portion of the tray assembly rests on the seat portion or seat cushion 204 of the second seat.

In this embodiment, the tray assembly 206 may be comprised of only a single tray portion 230 that includes recessed compartments 234, 236, 238 formed in an upper surface. Again, the compartments 234, 236, 238 may adopt various conformations as defined by the dividing walls 240 and the perimeter wall 242 and need not be necessarily shaped and sized as shown in the drawings. It is also contemplated that the tray 230 may include other foldout or expandable portions is desired.

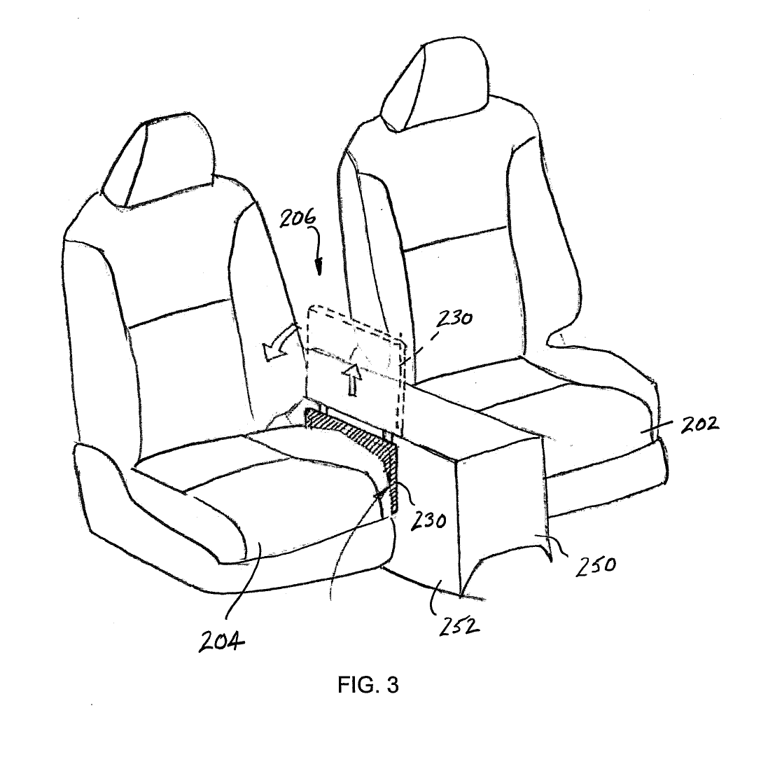

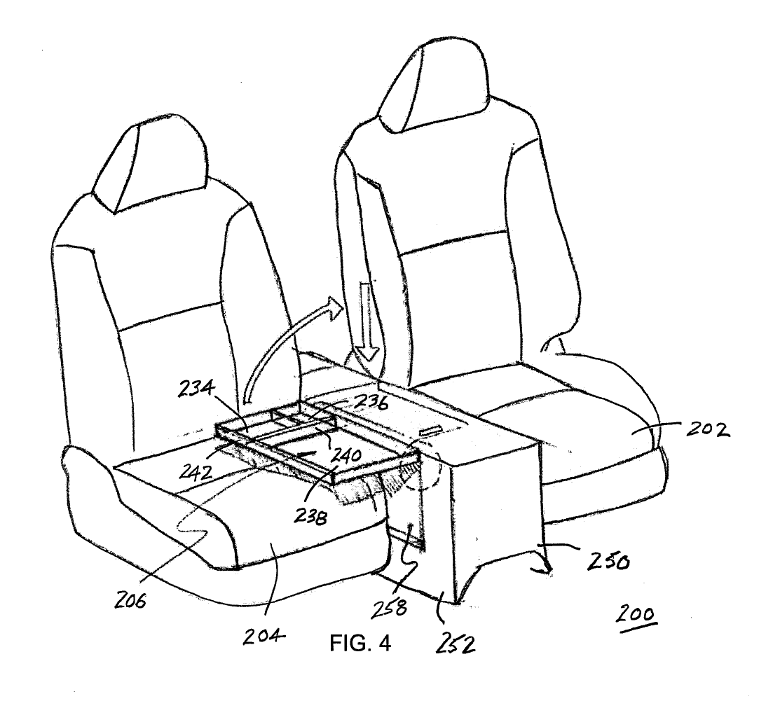

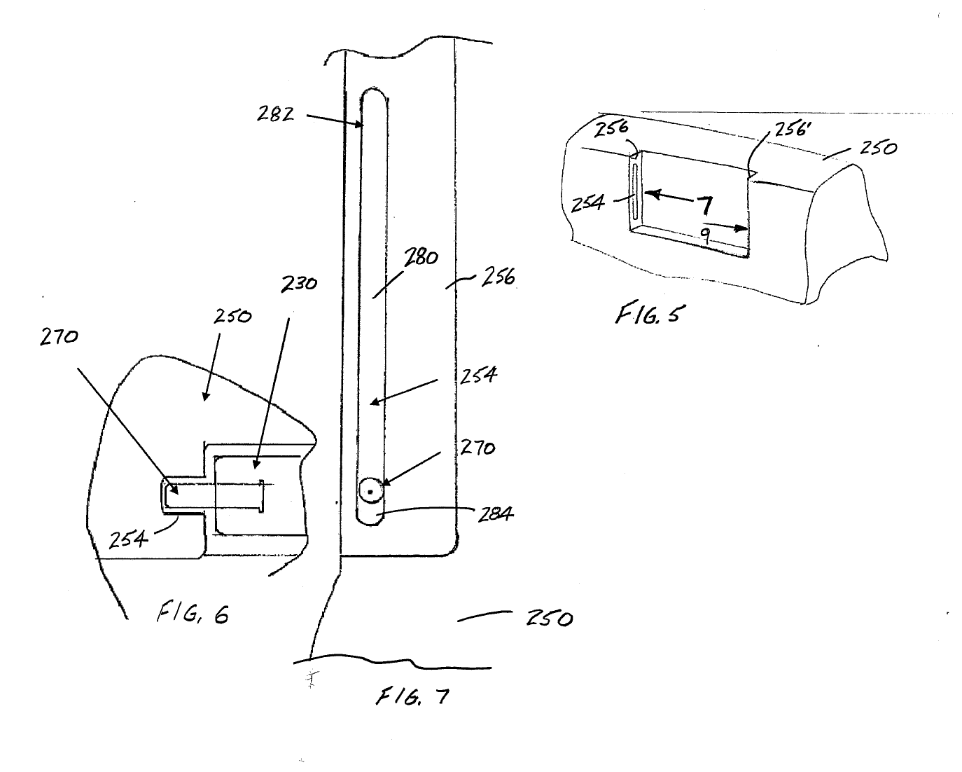

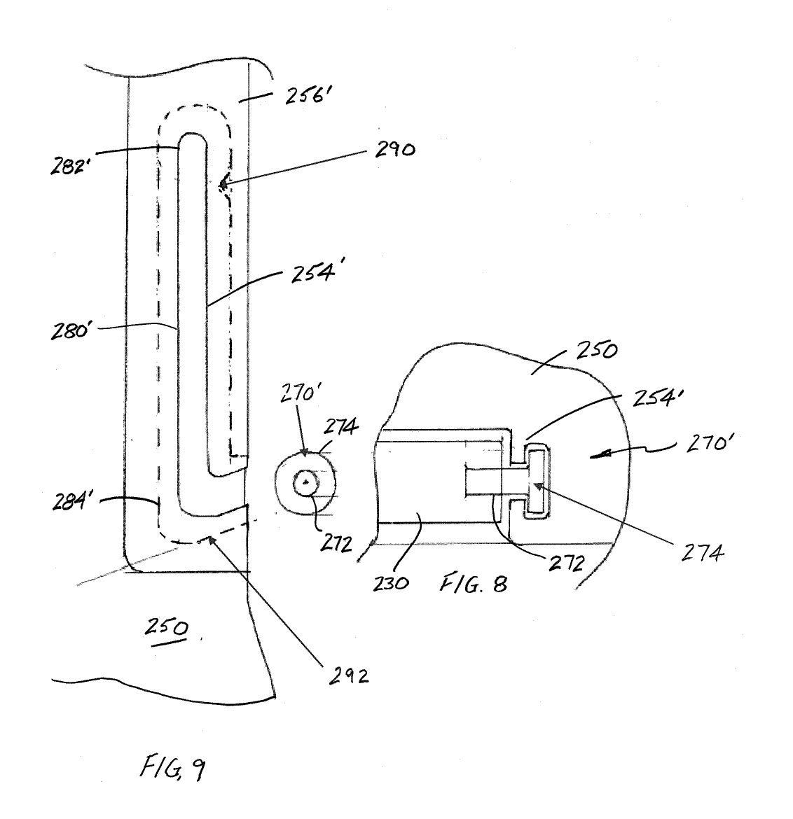

A mounting assembly is provided to move the tray between the stowed position of FIG. 3 and the in-use or deployed position of FIG. 4. The mounting assembly includes first and second mirror image channels or slots 254 (one channel 254 is illustrated in FIGS. 5 and 7 and the other channel is shown in FIG. 9) provided along respective perimeter edges 256 of recessed area 258 of the console. The recessed area 258 is dimensioned to receive the tray portion 230 in the stowed position. As particularly shown in FIG. 6, a projection or pin 270 extends outwardly from adjacent a corner of the tray portion 230 for receipt in the slot 254 while the projection 270′ on the other side of the tray is referred to as a guide key having a reduced dimension or necked down portion 272 and a smooth surface or roller portion 274 at the outer end that are received in an undercut slot 254′. Each channel 254, 254′ is substantially linear along a central portion 280, 280′ extending between first, upper and second, lower ends 282 (282′), 284 (284′), respectively. The pin 270 has a cross-sectional dimension substantially less than the width dimension of the slot 254 so that the pin can easily slide upwardly and downwardly within the slot. The upper ends 282, 282′ of slots 254, 254′ may each include a detent feature 290, 290′ or only the slot 254′ may include a detent feature that prevents the guide key 270′ and the tray portion 230 from falling once the tray portion is located in a deployed, at-use position.

The detent feature 290′ (290) is provided in the plastic material that forms the center console 250. The detent feature is not intended to support a large amount of weight since the tray portion 230 is received on the seat cushion.

In addition, the pin 270 and guide key 270′ allow for easy assembly at the factory. The pin 270 is initially inserted into the slot 254 preferably at the lower end 284. The guide key 270′is subsequently received into slot 254′, again at the lower end 284′. The customer can reverse these steps to easily remove the tray portion 230 from the center console for cleaning and subsequent re-installation.

Also evident in FIG. 9, is a ramp 292 that extends at an angle, for example at approximately 30° from horizontal, to prevent the guide key 270′ and tray portion from inadvertently falling out of the slots 254, 254′. Once the guide key 270′ is fully received through the ramp 292, the guide key is then positioned for vertical travel between the lower end 284′ and the upper end 282′ of the slot 254′.

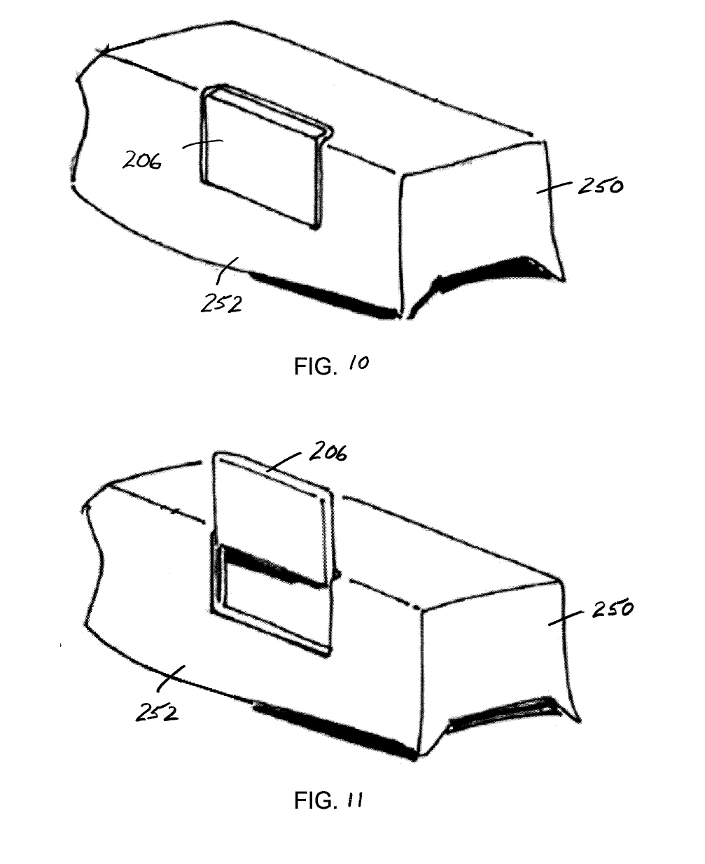

When the pin 270 and guide key 270′ are located in the lower ends 284, 284′ of the slots and the tray portion is oriented in a vertical direction, the tray portion 230 is recessed or received in flush relation relative to the console wall 252. By grasping an upper edge of the tray portion 230 from its stowed position, the projections 270, 270′ are advanced upwardly into the central, linear portions 280, 280′ and the tray portion can be moved in a vertical upward direction (to the dotted line representation in FIG. 3 and as sequentially illustrated in FIGS. 10-12). Once the projections 270, 270′ reach the upper ends 282, 282′ of the slots, the tray portion 230 can be rotated or pivoted downwardly toward the surface or cushion of the seat portion 204 of the second seat (see FIGS. 3, 4 and 13). Reversing these steps allows the user to move the tray portion from the in-use position to the stowed position. Likewise, the same mounting assembly arrangement can be used in the embodiment of FIG. 2 wherein the tray portion is conveniently mounted to the side of the seat rather than the sidewall of the console. In substantially all other respects, the mounting assembly functions in the same manner.

As a result, the tray portion 230 is mounted and hinged on a side of the center console. When the tray portion is in-use, the tray portion 230 will rest flat or level in the car and rest on the assistant or second seat cushion bolster surface. The tray portion preferably includes divided compartments for various small objects to be stored. Tray portion also contains a dock to position the phone for viewing by the driver. Tray portion may also contain a large surface of the rear toehold fast food items. Still further, when not in use, tray portion can be folded in stowed away in the recessed region on the side of the console beside the seat.

Preferably, the tray portion 230 is a plastic structure and may include stamped steel or aluminum brackets. The divided compartments in the tray portion preferably include non-slip surfaces. This eliminates problems associated with a sloped seat cushion. In addition, the walls of the tray have a height that provides sufficient restraint for small objects, food, phone, etc. It will also be appreciated that the stowed position is easily accommodated in the side of the center console, or wall seat in the embodiment of FIG. 2.

This written description uses examples to describe the disclosure, including the best mode, and also to enable any person skilled in the art to make and use the disclosure. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A tray assembly for an associated automotive vehicle having at least first and second side-by-side seats, each seat having a seat portion and a seat back, the tray assembly comprising:
a tray mounted between the first and second side-by-side seats; and
a mounting assembly receiving the tray for movement between a first, storage position located substantially below the seat portion of at least the second seat and a second, deployed position wherein at least a portion of the tray is configured to rest on the seat portion of the second seat.

2. The tray assembly of claim 1 wherein the first and second positions are substantially perpendicular to one another.

3. The tray assembly of claim 1 wherein the first position orients the tray in a substantially vertical orientation.

4. The tray assembly of claim 1 wherein the mounting assembly is positioned along a vertically extending face of a center console interposed between the first and second seats.

5. The tray assembly of claim 4 wherein the mounting assembly includes a recess dimensioned to at least partially receive the tray in a substantially vertical orientation.

6. The tray assembly of claim 1 wherein the tray has a generally planar conformation.

7. The tray assembly of claim 1 wherein the mounting assembly includes cooperating male and female portions that allow that tray to move between the first and second positions.

8. The tray assembly of claim 7 wherein the mounting assembly further includes a detent feature that aids in retaining the tray in the second, deployed position.

9. The tray assembly of claim 1 wherein the mounting assembly includes a recess formed in a sidewall of a console interposed between the first and second seats, the recess having a depth that closely approximates a thickness of the tray.

10. The tray assembly of claim 9 wherein at least one vertically extending edge of the recess includes a channel dimensioned to receive a projection extending outwardly from a perimeter edge of the tray and allowing selective sliding movement relative to the channel so that the tray can be moved between the first and second positions.

11. The tray assembly of claim 10 wherein the channel includes first and second control regions at opposite ends, the first control region allowing the tray to offset into the storage position substantially flush with a console sidewall.

12. A tray assembly for an associated automotive vehicle having front, first and second seats separated by a console disposed between the seats, each seat having a seat portion and a seat back, the tray assembly comprising:
a tray mounted to one of the second seat and the console between the front seats; and
a mounting assembly receiving the tray for movement between a first, storage position spaced from the seat portion of the second seat and a second, deployed position wherein at least a portion of the tray is configured to rest on the seat portion of the second seat.

13. The tray assembly as defined in claim 12 wherein the storage position of the tray is disposed in a different plane as the seat portion of the second seat.

14. The tray assembly as defined in claim 13 wherein the tray is pivotable between the storage and deployed positions.

15. The tray assembly as defined in claim 14 wherein the tray includes separate compartments in an upper surface when the tray is in the deployed position.

16. The tray assembly as defined in claim 12 wherein the storage position is in a substantially vertical plane along one of a side of the second seat or a side of the console disposed between the first and second seats.

17. A tray assembly for an associated automotive vehicle having front, first and second side-by-side seats separated by a console disposed between the seats, each seat having a seat portion and a seat back, the tray assembly comprising:
a tray mounted to either a side of the second seat or the console between the front seats; and
a mounting assembly receiving the tray for movement between a first, storage position spaced from the seat portion of the second seat alongside one of (i) a side of the second seat and a (ii) a top of the console, and a second, deployed position wherein at least a portion of the tray is configured to rest on at least a portion of the seat portion of the second seat.

18. The tray assembly of claim 17 wherein the tray is configured for pivoting movement between the storage and deployed positions in each of the configurations of (i) and (ii).

19. The tray assembly of claim 18 wherein the tray is configured for substantially vertical sliding movement between the storage and deployed positions when the storage position along the side of the second seat is secured to a side of the console.

20. The tray assembly of claim 17 wherein the tray includes a fold-out expandable portion.
